(19) United States
(12) Patent Application Publication
(10) Pub. No.: US 2007/0265953 A1
(43) Pub. Date: Nov. 15, 2007

(54) Smooth scrolling for software application

(76) Inventors: William D. Cunningham, South Barrington, IL (US); Andrew Busby, Aurora, IL (US)

Correspondence Address: MCGUIREWOODS, LLP, 1750 TYSONS BLVD, SUITE 1800, MCLEAN, VA, 22102, US

(21) Appl. No.: 11/431,146

(22) Filed: May 9, 2006

(51) Int. Cl. G06Q 40/00

(52) U.S. Cl. 705/37

(57) ABSTRACT

An improved method for monitoring commodities over an exchange having contracts with multiple markets is provided. Smooth scrolling embodiments in accordance with the present invention will move the pre-shift trading screen to a second position, the post-shift trading screen, which is dependent on which direction the market is moving. As the inside market changes, both the offers and bids change and therefore the inside market changes accordingly. As such, it is desirable for a user to be able to track the changes in the inside market and be able to see the highest bid price and the lowest offer price as the market changes on the user's trading screen.

### FIELD OF THE INVENTION

The present invention relates to the field of trading commodities. More particularly, the present invention relates to the improvement of a software application in order to trade commodities over an exchange. Even more particularly, the present invention relates to improving a software application to change the displays of the market data subscription in order to improve trading over an exchange. However, it is to be appreciated that the present invention is amenable to other like applications.

### BACKGROUND OF THE INVENTION

In general, commodities have been traded in the same way for hundreds of years. The Chicago Board of Trade (“CBOT”) began trading commodities in the 1800's. Since the inception of the CBOT, many different exchanges all over the world exist and each trade commodities. Many markets exist for each contract. One or more markets for each contract expire according to an exchange determined schedule. Typically, markets expire on the same day each month or the same day each quarter. This is called market expiration or “Roll Over.” A contract's current month is called the contract's front month. This may or may not be the month with a contract's first available outright market (first to expire).

More recently, electronic commodities trading has been added by the exchanges. This has permitted vast accessibility to these exchanges without requiring that a user be present within the exchange and without the necessity of “paper trades.” Not only has the use of electronic trading greatly increased the ability for users to trade commodities, but has also increased the market volatility, since there are more users that have easier and faster access to the exchanges.

Electronic trading of commodities is achieved through a combination of exchange hosts, Internet service providers (“ISPs”) and providers of trading platforms. Such providers would include application service providers (“ASPs”), independent service vendors (“ISVs”), and proprietary systems developed by clearing firms. The exchange hosts are primarily responsible for order routing, price dissemination and connectivity, which includes not only bidirectional communication but also preserving redundancy.

The trading platforms that are utilized in electronic commodities trading are responsible for, among other things, maintaining connectivity between the exchange hosts, local hosts and clients. Connectivity is maintained with respect to exchange hosts through bidirectional communication with redundancy. The local hosts are responsible for risk management throughout the trading day as well as the back office integration/imports. Local hosts are also responsible for accepting client connections, price dissemination and order routing.

The client is what the user interacts with directly. The client is responsible for maintaining its connection to the local host whether it is via the internet or through direct connection. The client typically includes a client session management feature which will monitor the connectivity of the client. Moreover, the client will typically include a configurable display that includes prices not only of the last trade, but also of the depth of market. The client also allows the user to manipulate orders, keep track of an order book and monitor account status, including balances, profit and loss and positions.

Each of the exchanges has requirements in order for the hosts and the clients to participate in the market. While the exchange interface is the same for all participants, each ASP, ISV and proprietary system interface can and does differ. Each company includes, for example, a custom trading front-end or platform, that it believes will be most accepted by the industry and become popular among traders and institutions. Trading tools such as described in the present invention optimize common procedures found in all trading platforms that are fundamental to electronic trading. In developing these types of trading tools it is the goal that user error be minimized, total user actions reduced and repeated actions simplified or eliminated. It is the differences in implementation that allow some systems to be more efficient than others.

Exchanges utilizing the present invention include a number of different contracts, where each contract is a commodity traded at an exchange that consists of one or more tradable markets of different expiry dates and/or one or more strategy markets. Although not all contracts have exchange provided strategies, many do. An exchange provided strategy market is a single tradeable market presented to the trader made up of one or more tradable markets per an exchange defined relationship. Strategies that are contemplated for use with contracts include Calendar Spread, Reduced Tick Calendar Spread, Butterfly, Condor, Double Butterfly, Horizontal Spread, Bundle, Pack, Pack Spread, Pack Butterfly, Bundle Spread, and others as would be appreciated by those of ordinary skill in the art.

The following invention has been designed for the electronic commodities trading industry. The invention is intended to be incorporated into electronic trading tools and software applications for trading commodities. The key to executing or manipulating trades in an electronic market is speed. Therefore embodiments in accordance with the present invention reduce the time it takes for a user to perform specific activities. The present invention thus improves the efficiency of user activities and adds value to an electronic trading system.

It is therefore advantageous for a user of software applications for trading equities to monitor what is known as the “inside market.” The inside market is the range of prices of contracts between the best (highest) bid price and the best (lowest) offer price. There may or may not be a gap in price levels between the two. Moreover, the highest bid can change independently of the lowest offer changing and vice versa. In addition, both may move at the same time in either the same direction or in opposite directions (moving apart from one another). It is within the inside market that a user will experience the most amount of activity and fluctuation. Therefore, it is advantageous to keep the trading screen (both pre and post shift) centered, or about centered, on the inside market.

### SUMMARY OF THE INVENTION

In accordance with one aspect of the present invention, an improved method for monitoring commodities over an exchange having contracts with multiple markets is provided. The method includes the steps of selecting a particular market based on a pre-determined exchange contract having a price level range and displaying a trading screen including the inside market for said market, wherein said inside market is defined by prices of the highest bid and the lowest offer. The method further includes calculating the center of said inside market, wherein said center of said inside market is determined by averaging the highest bid price and said lowest offer price and then automatically scrolling said trading screen such that said center of said inside market is substantially centered on the trading screen.

In accordance with a still further aspect of the present invention, an improved method for monitoring commodities over an exchange having contracts with multiple markets is provided. The method includes the steps of selecting a particular market based on a pre-determined exchange contract having a price level range and displaying a trading screen including the current market for said market, wherein said current market includes the price level corresponding to the last trade of the commodity. The method further includes calculating the center of said current market, wherein said center of said current market is determined by the price level corresponding to the last trade of the commodity and then automatically scrolling said trading screen such that said center of said current market is substantially centered on the trading screen.

In accordance with a yet further aspect of the present invention, an improved method for monitoring commodities over an exchange having contracts with multiple markets is provided. The method includes the steps of selecting a particular market based on a pre-determined exchange contract having a price level range and displaying a trading screen including the pre-open market for said market, wherein said pre-open market includes an indicative opening price level prior to the opening of the exchange. The method further includes calculating the center of said pre-open market, wherein said center of said pre-open market is determined by the price level corresponding to the indicative opening price level and then automatically scrolling said trading screen such that said center of said current market is substantially centered on the trading screen.

In yet another aspect of the present invention, an improved method is provided utilizing software for the monitoring of commodities. The method includes the step of automatically scrolling the user's trading screen at a pre-determined shift rate based on market changes.

In a further aspect of the present invention, an improved method is provided utilizing software for the monitoring of commodities. The method includes the step of automatically scrolling the user's trading screen at a pre-determined shift rate based on market changes, wherein said shift rate is between 2 to 10 pixels per 100 to 1000 milliseconds.

In accordance with another embodiment of the present invention, said trading screen trading screen displays a grid having more than one row, each consecutive row corresponding to a consecutive valid price level, wherein said valid price level includes all prices levels without regard to whether a market volume exists at those prices, and at least two columns, wherein said columns include a bid column and an offer column.

In accordance with a further embodiment of the present invention, said grid includes multiple cells, wherein each cell corresponds to a particular bid or offer at a price level.

In accordance with a still further embodiment of the present invention, each cell within said grid includes a number that corresponds to the number of bids or offers that exist for a particular price level.

In accordance with still another embodiment of the present invention, said cell includes a colored bar, wherein said bar is a graphical representation of the number of bids or offers that exist for a particular price level.

In accordance with yet another embodiment of the present invention, the physical size of the graphical representation of said colored bar is calculated using the depth quantity of that price level as the numerator and a grid basis for the denominator.

In accordance with a yet another embodiment of the present invention, each cell within the grid is an individually defined area responsive to pointer action of a user interface cursor over said defined area.

In accordance with a still further embodiment of the present invention, said cursor automatically stays within the boundaries of the defined area.

In accordance with a further embodiment of the present invention, a user action of said user interface cursor on said cell facilitates the submission of an order to an exchange.

In accordance with another embodiment of the present invention, said order is a trade of a commodity over an exchange.

### BRIEF DESCRIPTION OF THE DRAWINGS

FIG. 1 illustrates an exemplary embodiment of a client component used in conjunction with software applications that are contemplated for use in accordance with the teachings of the present invention.

FIG. 2 illustrates an exemplary embodiment of a server component used in conjunction with software applications that are contemplated for use in accordance with the teachings of the present invention.

FIG. 3 illustrates an exemplary embodiment in accordance with the teachings of the present invention.

FIG. 4 illustrates yet another exemplary embodiment in accordance with the teachings of the present invention.

### DETAILED DESCRIPTION OF AN EMBODIMENT OF THE INVENTION

In accordance with one embodiment of the present invention, an improved software application is provided in order to reduce the time it takes a user to place an electronic trade. In particular, embodiments in accordance with the present invention are utilized with commodities trading software in order to increase the efficiency of a user and allow the user to monitor the status of prices, bids and offers for commodities before deciding to buy or sell a commodity.

Software applications that can be used with the smooth scrolling embodiments in accordance to the present invention typically include four main parts: a backend, an application program interface (API), a client and a server.

The backend of software applications for trading commodities over an exchange typically includes a historical order book, which keeps a record of all of the orders placed by a user. In addition, the backend will typically store reports related to the users order activity and order routing performance. The backend will also preferably allow for back office statement publishing.

In addition, the backend of software applications for trading commodities over an exchange will preferably also include an administration component. The administration component can include a number of features or tasks for the software application including, but not limited to, general system maintenance, organization of applications, database of firms, database of trading accounts and a database of users.

General system maintenance within the administration component can include storing various configurations of the software application, including graphical user interface defaults and options. Moreover, the general system maintenance may include monitoring between the network backend and the client portion of the software application to insure, for example, that a network connection is continually maintained and to inform if there is a broken network connection. The general system maintenance may also include maintenance, for example, involving anti-virus updates, software application updates, debugging updates and the like.

Applications for use with software applications used in conjunction with the present invention include those applications that provide organization of licenses, which for example, authorize a user to perform trades of commodities. In addition, the licenses and other applications may be organized to enable or disable certain licenses depending on the level of authorization of the user of the software application. For example, a user may only be authorized to trade a certain monetary value, and therefore, the software license that allows that user to trade may be disabled above the predefined value. As a further example, the application may be only licensed to users that have a certain series of license, e.g., depending on the API.

In addition, the backend component of software applications for use with the present invention may also include a database that allows for organization of firms. This allows the user to create and edit the firms with the database, as well as enable and disable firms' access to the software applications. In addition, the database of firms can include information including the assignment of applications, the configuration of branding, the assignment of firm roles, and the selection of exchanges and setting the executing logins. The assignment of firm roles includes, for example, any of trading, pit trades, data files, self registration and refer self registration.

The backend component of software applications for use with the present invention preferably also includes a database of trading accounts, which also allows for the user to create, edit, delete and adjust account specific risk specific parameters. In creating trading accounts, the database will preferably include information such as the account number, risk parameters and any details that are required by the exchange.

Further, the backend component of software applications for use with the present invention may include a database of users, which allows the user to create, edit or delete users of the software application. In creating a user, the database will preferably include information such as the assignment of a user name and password, user contact details, the assignment of accounts and the assignment of user roles. The user roles that have been assigned may include information relating to the administrator, the risk manager, trades, pit trades as well as data files.

Software applications for use with the present invention also typically include an application program interface (API). The API consists of a set of objects or methods included with the client. The API provides developers a standard programming interface for communications with the server. Applications that interface with the server typically implement the API.

The API provides all of the objects necessary to trade the software applications supported electronic futures exchanges. Included are methods for market data subscription as well as risk managed order routing.

To develop an API for use with the present invention, a development tool is typically utilized, such as Microsoft Visual Studio Net. At a minimum, the API establishes a session with the server by supplying certain parameters, including, for example, the application license, the server URL, the server type (for example, simulation or live) and the firm, username and password. It is preferred that the above parameters be hard coded with the exception of the firm, user name and password, which is preferably a user input at runtime.

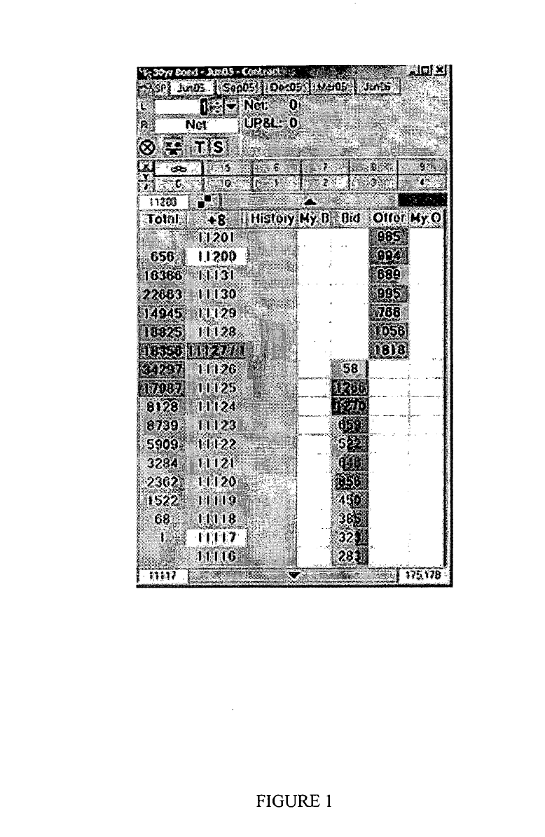

Software applications for use with the present invention also preferably include a client component. The client is an Internet-based system that can be accessed from anywhere in the world and offers access to multiple futures exchanges and provides a custom trading front-end that is intended for professional and retail users. An example of a client component contemplated for use with the present invention is shown at FIG. 1.

The client component preferably provides a contract window as the main order execution window. The contract window displays data for a single market at a time. The contract window provides the ability for the trader to select between available markets. There are typically three main columns: price, bid and offer. The price column is typically a vertical list of market prices listed in descending order from top to bottom. Every valid market price is preferably listed with no gaps in the prices. The bid and offer columns preferably run parallel to the price column and display the current market depth (bids and offers at each price). For example, if there were 3 users attempting to buy 5 March Mini Dow contracts each at 11100, the bid column would display a 15 at the intersection of the Bid column and the 11100 row. If those 3 people then attempted to sell 5 March Mini Dow contracts, each at 11108, the offer column would display a 15 at the intersection of the offer column and the 11108 row. Both examples assuming that there were no other traders in the market.

The client software, once installed onto the user's computer, includes a main window which preferably includes a number of user controlled settings, such as the currently trading account, creating new items, change global properties and save global properties. In addition, the profit and loss and cash for the currently trading account are preferably displayed. The lower portion of the main window preferably includes information such as the software application status, any status messages and the user name.

Software applications for use with the present invention also preferably include a server component. The server component is typically an n-tier distributed application that is designed to be robust, secure and scalable. The server preferably consists of a number of tiers, including: an ExchangeHandler, an AccountHandler and a UserHandler. Each of these can be run on separate servers, or they can all be run on the same server, or any combination thereof. Multiple instances of each tier can be run at the same time to achieve load balancing and failover redundancy. Each tier communicates with the others using messages sent over TCP/IP sockets, multicast or Message Queue services.

The ExchangeHandler typically deals with the communication with the actual futures exchanges, such as CBOT, CME, etc. This tier effectively provides a common interface for the rest of the applications to communicate with different exchange technologies (such as LIFFE Connect, FIX, etc.).

For each exchange that the system communicates with, a Driver is typically created that deals with the translation between that specific exchange API and the varying data formats of the software application. The Driver updates caches of information within the ExchangeHandler with updates to that market data, quotes or orders. Then ExchangeHandler typically then deals with forwarding that information onto the AccountHandlers and UserHandlers based on what information they have subscribed to get.

The AccountHandler is typically central for the accounts and orders for the current day in the system. The orders submitted by a user are typically sent through the AccountHandler and checked for various risk management parameters, such as maximum size, margin requirement, etc., before being sent to an ExchangeHandler for sending to the actual exchange. When an order is confirmed by an exchange, or is filled or cancelled, the message is forwarded from the exchange, via the ExchangeHandler, to the AccountHandler where the order record is updated to reflect the new state of the order. The updated order state is then sent to the end-user via the UserHandler.

Servers for use with the present invention also preferably include a UserHandler. The UserHandler typically deals with the connections established by the end-users with the front-end, typically via the API. Access to the system by an end-user is preferably achieved through this component. The UserHandler preferably maintains a secure connection with the user via SSL encryption, and for authenticating the user and the permissions that the user has been assigned. It is contemplated that other means of maintaining a secure connection and authenticating users and permission may be implemented as would be appreciated by those of ordinary skill in the art.

Quote data from the exchanges and the order and trade confirms from the AccountHandler are preferably forwarded through the UserHandler to the end-users depending on the data that each user has subscribed to. Orders submitted and requests for data from the end-user are typically processed through the UserHandler first, and then forwarded to the appropriate account handler or exchange handler.

It is advantageous to have many instances of the UserHandler tier, preferably on multiple machines, which would allow for hundreds or thousands of users to be connected to the system at the same time. If one instance failed, the users connected to it would automatically reconnect to another instance causing minimal outage time for the end-user.

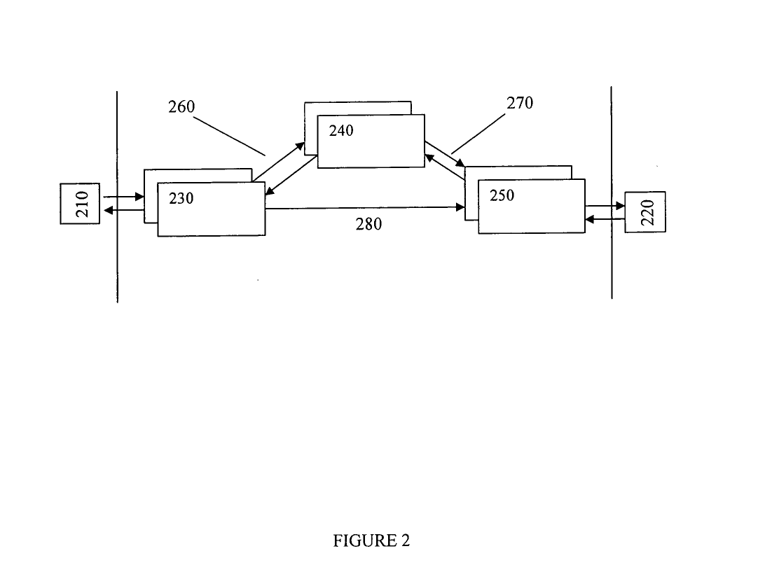

Server components contemplated for use with the present invention typically are in the format described in the flowchart of FIG. 2.

It is contemplated that software applications including smooth scrolling embodiments in accordance with the present invention may utilize any number of the components described herein.

Software applications utilizing smooth scrolling embodiments in accordance with the present invention are benefited by providing a market depth display that dynamically centers the market Since the system centers the market dynamically, the frequency and/or likelihood that a user would have to center the market manually is lowered. Manual centering is still required in cases of extreme market conditions where the market moves at a faster pace than the dynamic centering.

Smooth scrolling embodiments of the present invention are an enhancement to the traditional, always centered, market depth display, in that the user is able to perceive the direction in which the market is moving. In addition, embodiments of the present invention allow for the scroll speed and the distance to be modified in order to allow orders to be rapidly entered at the desired prices with a minimum number of errors on the user's part.

One advantage of smooth scrolling embodiments of the present invention is that it is unnecessary for manual centering of the trading grid. This is advantageous to users that trade on tablet personal computers (or the like) in the trading pits. These users split their focus between the activities in the electronic market and the activities in the trading pit. Capturing the short-lived price differentials between electronic and pit markets requires a great deal of speed and the time saved by not having to manually center the market may mean the difference in making a successful trade and missing it. Thus, needless time centering a market grid is avoided.

In accordance with a preferred embodiment in accordance with the present invention, market depth is displayed vertically in a grid. Prices are listed in a first column, bid depth in a second and offer depth in a third column. Each individual depth quantity appears in a cell where the price level row and bid/offer depth column intersect. The cells also double as order entry regions. Orders can be executed, pulled and revised depending on the type of action taken in these regions. It is contemplated that other configurations may also be used in conjunction with embodiments of the present invention as would be appreciated by those of ordinary skill in the art.

As the market moves up or down, the software application will automatically shift the system such that the depth display is kept with the best bid and best offer prices near the center. It is contemplated that a user of software applications employing embodiments in accordance with the present invention may input from a number of different options what characteristic of the market will be kept near the center of the display of the market grid. Although it is contemplated that the market be centered, it is to be understood that centering will not necessarily be exact in accordance with the present invention. Preferably, the market is centered such that the likelihood of a user having to center the market manually is decreased. As such, one preferred embodiment in accordance with the present invention centers the market to a range of about three rows in the middle of the grid, i.e., if it is currently one row below center and the inside market has not changed, there will be no smooth scrolling. This reduced the amount of oscillation that the grid performs when a market is changing but not moving in any particular direction.

Preferably, different market conditions utilize different behavior from software applications. The shift increment and shift time interval are both variables that are calculated in real-time based on a number of different factors. Some factors include: the distance that the market is from center, the elapsed time since the last centering and the width of the best bid/offer spread. It is to be understood that many other factors could be used, as would be appreciated by those of ordinary skill in the art. Preferably, in accordance with an embodiment of the present invention, the shift is approximately one row height every two seconds in normal market conditions and default font size. Since large or unpredictable movements would increase the possibility that a user would act upon an incorrect order entry region, it is contemplated that the default speeds be fast enough to keep up with normal market conditions, yet slow enough to allow a user to act upon an order entry region. It is understood that those of ordinary skill in the art would be able to determine the default speeds to be used depending on a number of factors, including the experience of the user with such a system.

In order to decrease the amount of time it takes for a user to perceive a change to the inside market, the center of the market is preferably calculated prior to display. This allows for the display of the market grid to be rendered with the initial shift and updated depth values at the same time. By doing so, every change to the center of the inside market preferably results in a dynamic shift of the market. It is preferable that there is no instance where the inside market's center changes without a shift. This is preferable since a user's peripheral vision picks up a shift in the market much more quickly then a depth quantity change.

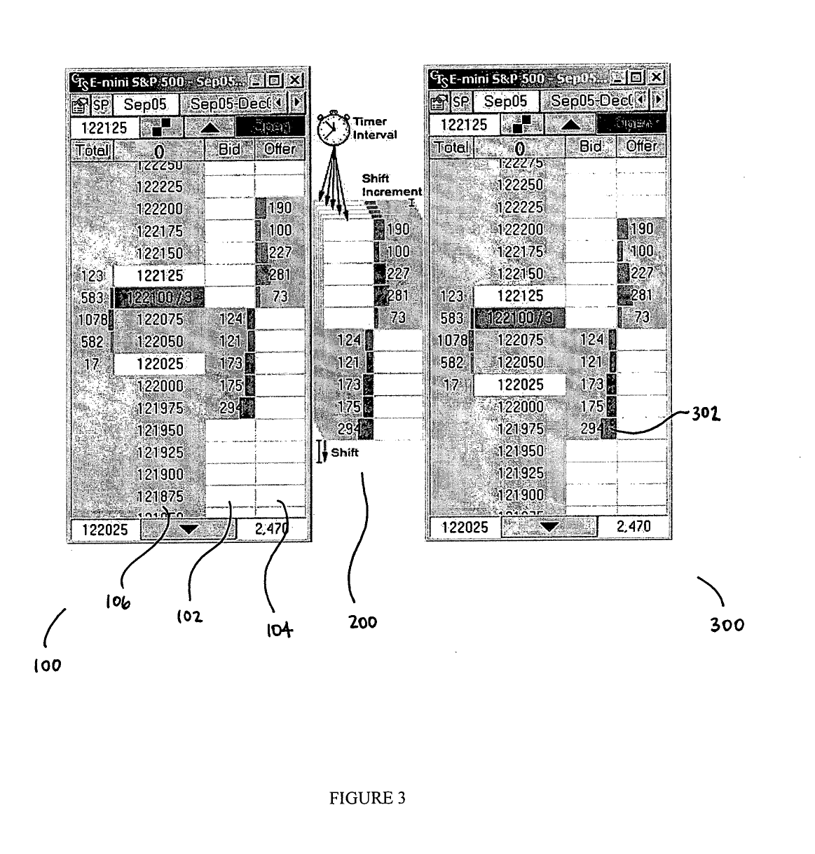

Smooth scrolling in accordance with one embodiment of the present invention is shown in FIG. 3. As displayed, the pre-shift trading screen 100 illustrates the trading of a September 2005 contract. The pre-shift trading screen 100 includes several regions, as described above, and includes a vertical bid column 102 and a vertical offer column 104 aligned with the bid column 102, both of which are aligned with a price column 106. The bid column 102 provides the user with information regarding the number of bids that exist for the commodity at each price. In the example of FIG. 3, there are 124 bids for the price of 122075. The offer column 104 provides the user with information regarding the number of offers that exist for the commodity at each price. In the example of FIG. 3, there are 73 offers for the price of 122100. When a bid or offer is met with a suitor, that bid or offer is removed from the pre-shift trading screen 100. Also, bids and offers can be withdrawn, and additional bids and offers can constantly be added. The placement of bids and offers can also be affected by forces in the market, news announcements, and a number of other factors. For these reasons, the pre-shift trading screen 100 can sometimes reflect substantial amounts of activity, and the bids and offers may quickly move up and down the price column 106.

As the inside market changes, both the offers and bids change and therefore the inside market changes accordingly. As such, it is desirable for a user to be able to track the changes in the inside market and be able to see the highest bid price and the lowest offer price as the market changes. Smooth scrolling embodiments in accordance with the present invention will move the pre-shift trading screen 100 to a second position, in this case the post-shift trading screen 300 moves downward, which is dependent on which direction the market is moving and allows the user to always see the inside market.

Some prior trading software applications were static and, as such, when the market moved, i.e., the offer and bid prices changed, the trading screen for the user would remain the same, even though the inside market would not necessarily be displayed in the user's active trading screen. Other prior trading software applications were fully dynamic, meaning that a regular depth window that shows the top “n” bids and offers as a simple list in one or two columns without any gaps in the prices.

However, embodiments in accordance with the present invention average the best bid and the best offer (the inside market), and then scroll the price column (and adjoining by bid and offer columns) until the computed average is in the middle, or near the middle, of the display. This permits the best bid and the best offer to be generally centered on the user's trading screen and therefore within the view of the user without having to manually scroll to determine the mid-point of the inside market.

As stated herein, the inside market for a contract is constantly changing. As such, in accordance with embodiments of the present invention, the midpoint of the inside market is calculated and the user's trading screen is shifted accordingly. Preferably, the rate of shifting of the trading screen occurs at a speed of 3 pixels per 300 milliseconds. It is contemplated, however, that any shift rate can be used with the present invention and that the shift rate can depend on many factors, such as user's preferences, the distance the market is from the center, the elapsed time since the last centering, width of the best bid/offer spread and volatility of the market.

An illustrative embodiment in accordance with the present invention is shown, for example, at FIG. 3. As can be seen, the pre-shift trading screen 100 is shifted downwards to the post-shift trading screen 300 position. The shift rate 200 has two components to it, the timer interval and the shift increment. Both of these components can be adjusted by the user in order to customize the user experience. A default shift rate is approximately 3 pixels per 300 milliseconds. It is contemplated however, that various ranges can be used, for example, allowing adjustments in the ranges from 2 to 10 pixels and 100 to 1000 milliseconds. Alternatively, the rate could be variable based on real time calculations or an algorithm.

Furthermore, as indicated in the embodiments illustrated in FIG. 1 and FIG. 3, the market depth is displayed on the trading screen grid, in this instance, the market depth is displayed vertically. The market depth is the display of the working limit orders at the exchange that surround the current market price. When two traders agree on a price their orders will be matched as a trade and the current market price established. As shown in FIG. 3, prices of contracts are listed in the price column 106, bid prices in the second column 102 and offer prices in the third column 104. For each corresponding price in the bid and offer columns, the cell of the trading screen grid also includes an illustration that represents the depth for that particular price. This qualitative illustration is proportional to the number of bids and/or offers for that particular price. For example, in trading screen 100, there are 294 bids corresponding to the price 121975. The cell in the bid column 102 thus illustrates a bar graph representation for 294 bids. Contrast with the cell in the bid column 102 for the number of bids for the price of 122050, and it is only 121 bids at that price. The bar graph representation for the number of bids of the price 122050 is thus much smaller than that for 121975. This allows the user to quickly glance through the columns and see where the most bids and offers are without having to read and compare each of the numbers.

Although the shift rate is generally defined to encompass all movements in the inside market, it is contemplated that their may be occasions in which the inside market is changing so rapidly that the shift rate that is chosen by the user may not be effective, i.e., may not allow the inside market to be centered on the user's trading screen. In such instances, it is contemplated that a user preference may be set up to automatically change the shift rate. Alternatively, it is contemplated that the user's trading screen may include a “page up” or “page down” button in order to quickly scroll several prices in the desired direction. Additionally, the user's trading screen may include a “re-center” button or the like to allow the user to quickly click one button and return to the center of the inside market. Those of ordinary skill in the art would appreciate a number of different ways in which to allow the user to quickly re-center the inside market to the user trading screen.

It is to be appreciated by those of ordinary skill that embodiments in accordance with the present invention can be achieved using a computer program. For example, the computer code can be utilized in implementing certain embodiments in accordance with the teachings of the present invention, as set forth in Exhibit A, attached hereto.

In still other embodiments in accordance with the present invention, a method for decreasing the likelihood that a user will submit an order at an incorrect price is provided for a system centered market depth order entry screen. System centered screens attempt to shift the market depth display so that the current market price remains near centered. Users run the risk of acting upon undesired order entry regions as they are shifted beneath the user's mouse cursor. As such, it is desirable to force the mouse cursor to remain positioned relative to the moving depth display and its order entry regions.

One advantage of embodiments in accordance with the present invention that utilize a mouse cursor that follows a moving depth display and its order entry regions is that the user can use the system centered market depth order entry screens without fear of submitting orders at an incorrect price. Once a user has positioned their mouse cursor over a desired location within the depth display, i.e., the desired price level, the user can be confident in the mouse actions regardless of how much the display is moving.

Typically, a mouse cursor maintains its position within the physical boundaries of the display of a computer monitor and does not change its position with respect to the images displayed beneath the mouse cursor on the monitor without some user interaction. In accordance with embodiments of the present invention, however, the mouse cursor follows a moving depth display and its order entry regions when activated by being located in specific boundaries of the display. A user is able to move the mouse cursor in and out of these defined areas. The defined areas may be pre-determined by the user or may be dynamically generated by the software application. If the user were to scroll the mouse cursor over one of the defined areas, the “mouse follow” behavior is activated, thus the location of the mouse cursor relative to the moving display will remain in the defined area. The instant that the user scrolls the mouse cursor out of one of the defined areas, normal mouse cursor behavior will resume. Therefore, in a grid that includes a number of defined areas to activate the mouse follow behavior, the user will not have to worry about where the mouse cursor is and whether there will be in an error in selecting a particular area of the grid.

In one embodiment in accordance with the present invention, market depth is displayed vertically in a grid. Prices are listed in a first column, bid depth in a second column, and offer depth in a third column. It is contemplated that other columns may be included, or alternatively used instead of prices, bid depth and offer depth, as would be appreciated by those skilled in the art. Varying columns may be preferred depending on the particular objective sought to be achieved by the user of the software application. Each individual depth quantity appears in a cell where the price level row and bid/offer depth column intersect. These cells may also double as order entry regions. Orders can be executed, pulled and revised depending on the type of action taken in these regions.

Software applications utilized in accordance with embodiments of the present invention, particularly, the client portion, include a contract window, which is a system centered market depth order entry screen. As the market moves the system automatically shifts the depth display to keep the best bid and best offer centered, or as close to it as possible depending on the volatility of the market. In some instances, the market may be so volatile so as to not allow the depth display to be perfectly centered. It is to be appreciated by those of ordinary skill that one of the key goals is to ensure that the user can visibly see the best bid and best offer price levels. The depth display area preferably includes defined areas so as to activate the mouse follow feature, thus ensuring that the mouse cursor will remain positioned relative to the moving depth display.

Exemplary embodiments in accordance with the present invention includes instances where the mouse cursor is moved by the user over an order entry region of the market depth display. Accordingly, the system centered market depth order entry screen shifts two pixels up and the mouse cursor is also shifted (not by the user) two pixels up. Thus, the user does not have to worry about missing an entry region or having the incorrect region shift under the mouse cursor before the user performs a mouse action.

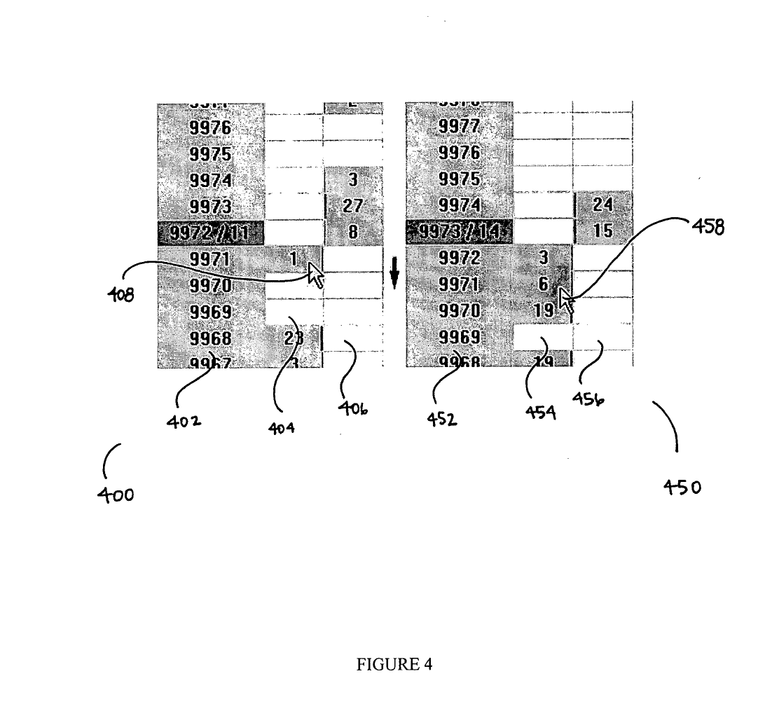

As shown in FIG. 4, a mouse follow embodiment in accordance with the present invention is shown. As can be seen, the depth of market is displayed before 400 and after 450 a shift in the market. The depth of market includes a pre-shift price level column 402, a pre-shift bid column 404 and a pre-shift offer column 406. The shift in the market is due to the volatility in the market. The pre-shift mouse cursor 408 is placed by the user on a desired defined region prior to the market shifting. Once the market shifts, the post-shift mouse cursor 458, through no action on the part of the user, remains on the same defined region, even though the physical location is actually different. Thus, the mouse cursor 458 is shown at the same location relative to the depth display (in this instance, price level 9971) but at a different location relative to the physical bounds of the computer monitor screen and relative to the post-shift price level column 452, post-shift bid column 454 and post-shift offer column 456.

It is to be appreciated by those of ordinary skill that embodiments in accordance with the present invention can be achieved using a computer program. For example, the computer code can be utilized in implementing certain embodiments in accordance with the teachings of the present invention, as set forth in Exhibit B, attached hereto.

In still other embodiments in accordance with the present invention, the time it takes for a user of software applications for trading commodities to recognize the relative strength of the market is reduced. Any number of price levels can be compared visually without having to read numerical values. Each price level displays a graphical representation of its depth in proportion to a value shared by all price levels. As such, this feature is preferably incorporated and used as an enhancement to existing trading tools for trading commodities over an exchange. Embodiments in accordance with the present invention allow a user to quickly evaluate the relative strength of the market at each price level without having to numerically compare individual numbers, which takes more time. Furthermore, embodiments of the present invention reduce human error in reading numerical values; instead, the user is simply evaluating a graphical representation, which greatly reduces human error. This is advantageous for users, especially when trading multiple volatile markets simultaneously.

In one embodiment in accordance with the present invention, market depth is displayed vertically in a grid. As explained herein, prices are listed in a first column, bid depth in a second column, and offer depth in a third column. It is contemplated that other columns may be included, or alternatively used instead of prices, bid depth and offer depth, as would be appreciated by those skilled in the art. Varying columns may be preferred depending on the particular objective sought to be achieved by the user of the software application. Each individual depth quantity appears in a cell where the price level row and bid/offer depth column intersect. These cells may also double as order entry regions. Orders can be executed, pulled and revised depending on the type of action taken in these regions.

Each cell within the grid that contains a depth quantity also preferably displays the depth proportion graphically (qualitatively) in the cells background. The depth proportion numerator is the depth quantity and the denominator is a value shared by all price levels to make sure that all cells are comparable from the same basis.

Preferably, a solid bar of color is used to display the depth proportion. The bar is typically of the same height as the cell and is preferably aligned with either the cell's left or right edge. It is contemplated that bars of other configurations may be utilized to achieve the goals of the present invention as would be understood by those of ordinary skill in the art. The width of the bar changes with the depth quantity so that the depth proportion and the width of the bar are of the same ratio. Traditionally, trading software systems display market depth with the bid column in blue and the offer column in red. While color has been used to distinguish bid from offer depth quantities, color has not been used to distinguish each individual depth quantity at every price level.

A depth quantity ration is calculated for each cell containing a depth quantity. A proportional color bar representing this ratio is displayed in the cell's background. As depth quantities change, the ratios are recalculated and the color of the bar changes width accordingly.

The depth quantity ratio is preferably calculated based on a market depth update. The numerator of the ratio is a price-specific depth quantity. The denominator of the ratio is a configurable value that is shared with all price levels on the grid. As explained above, this allows the user to be confident that all of the price levels are using the same basis and that the ratio's for each of the price levels can be easily compared. Preferably, a user-defined value is used for the denominator, although it is also contemplated that the denominator may be dynamically generated via the software application based on predefined parameters for the graphical user interface. A user may adjust the denominator based on any number of factors, including the user's personal preferences, differences in the way individual markets trade, and changes to a market's conditions throughout a trading day/week. For example, if a current depth quantity at a given price is 200 and the denominator is 1000, the depth ratio would be 200/1000, or 20%. In this example, 20% of the cell's background would include a color bar in order to qualitatively indicate the ratio.

The depth quantity ratio is preferably used to calculate the width of the color bar used to display the proportional volume at that price level. Multiplying the cell width (in pixels) by the depth quantity ratio equals the width of the color bar in pixels. For example, if the cell is 150 pixels wide, then 150 multiplied by 0.2 (or 20%) would be equal to 30 pixels. In the example, the color bar will be 30 pixels wide.

After these calculations are made, the color bar can be displayed. These calculations are preferably made dynamically, as the market moves. It is also contemplated, however, that the calculations may be made at a pre-determined time rate or at the request of the user, for example, by clicking a “refresh” button or the like. Offers are preferably displayed in two shades of red and bids are preferably shown in two shades of blue. The color bars are displayed in the darker shades and the remaining portions of the cells are displayed in the lighter shades. The color bars can be left or right justified within the cell borders.

FIG. 3 is exemplary of embodiments in accordance with the present invention. As can be seen throughout the grid, a number of colored bars depict the proportional strength of the market. For example, the cell representing the bid price level 302 for the price level of 121975 depicts both qualitatively and quantitatively the number of bids that exist at that price level. As shown, the “294” within the cell 302 represents the numeric strength of the market. Moreover, the bar within the cell 302 has a width that is proportional to the strength of market, as described above. As can be seen in FIG. 3, not only is the “294” number of bids the highest number of bids (or offers) shown in the exemplary market, but also, the width of the bar within the cell 302 is also the largest bar on the grid. A brief survey of the numerical representation of the numbers of bids and offers remaining cells on the grid makes apparent that the 294 number of bids is the most. Accordingly, the bar that corresponds to the 294 bids is also the largest bar of any within any cell on the grid.

The invention has been described with reference to preferred embodiments. Obviously, modifications and alterations will occur to others upon a reading and understanding of this specification. It is intended that the invention be construed as including all such modifications and alterations insofar as they come within the scope of the appended claims or the equivalents thereof.

Exhibit A:

A market update is received by the Client from the API
SET oBestBid to the current best bid price
SET oBestOffer to the current best offer price
CALL ShiftMarket
ELAPSE ShiftTimer

CALL ShiftMarket

End ShiftTimer
ROUTINE ShiftMarket

Set oMarketCenterPrice to (oBestBid + oBestOffer) / 2
Set oDisplayCenterPrice to the price displayed at the center of the
display
IF oMarketCenterPrice <> (not equal to) oDisplayCenterPrice THEN

SET oShiftIncrement to the optimal shift distance based on
market conditions.
SET oShiftTimeInterval to the optimal time interval based on
market conditions.
Shift the market depth display by oShiftIncrement so that
oMarketCenterPrice is moving toward the center
Display market depth containing the market update
SET ShiftTimer time interval to oShiftTimeInterval
START ShiftTimer

ELSE

STOP ShiftTimer

END IF

END ROUTINE ShiftMarket

Exhibit B:

A market update is received by Client from the API
SET oBestBid to the current best bid price
SET oBestOffer to the current best offer price
SET blnMouseFollow to True if mouse follow is enabled otherwise False
CALL ShiftMarket
ELAPSE ShiftTimer

CALL ShiftMarket

End ShiftTimer
ROUTINE ShiftMarket

Set oMarketCenterPrice to (oBestBid + oBestOffer) / 2
Set oDisplayCenterPrice to the price displayed at the center of the
display
IF oMarketCenterPrice <> (not equal to) oDisplayCenterPrice THEN

SET oShiftIncrement to the optimal shift distance based on
market conditions.
SET oShiftTimeInterval to the optimal time interval based on
market conditions.
Shift the market depth display by oShiftIncrement so that
oMarketCenterPrice is moving toward the center
IF blnMouseFollow = True THEN

Shift the mouse cursor by oShiftIncrement so that it
maintains its position within the moving display

END IF
Display market depth containing the market update
SET ShiftTimer time interval to oShiftTimeInterval
START ShiftTimer

ELSE

STOP ShiftTimer

END IF

END ROUTINE ShiftMarket

What is claimed is:

1. An improved method for monitoring commodities over an exchange having contracts with multiple markets, the method utilizing a software application, comprising:
selecting a particular market based on a pre-determined exchange contract having a price level range;
displaying a trading screen including the inside market for said market, wherein said inside market is defined by prices of the highest bid and the lowest offer;
calculating the center of said inside market, wherein said center of said inside market is determined by averaging the highest bid price and said lowest offer price; and
automatically scrolling said trading screen such that said center of said inside market is substantially centered on the trading screen.

2. The method of claim 1 wherein said automatically scrolling scrolls at a pre-determined shift rate.

3. The method of claim 2 wherein said shift rate is between 2 to 10 pixels per 100 to 1000 milliseconds.

4. The method of claim 3 wherein said trading screen displays a grid having more than one row, each consecutive row corresponding to a consecutive valid price level, wherein said valid price level includes all price levels without regard to whether a market volume exists at those prices, and at least two columns, wherein said columns include a bid column and an offer column.

5. The method of claim 4 wherein said grid includes multiple cells, wherein each cell corresponds to a particular bid or offer at a price level.

6. The method of claim 5 wherein each cell within said grid includes a number that corresponds to the number of bids or offers that exist for a particular price level.

7. The method of claim 5 wherein said cell includes a colored bar, wherein said bar is a graphical representation of the number of bids or offers that exist for a particular price level.

8. The method of claim 7 where the physical size of the graphical representation of said colored bar is calculated using the depth quantity of that price level as the numerator and a grid basis for the denominator.

9. The method of claim 5 wherein each cell within the grid is an individually defined area responsive to pointer action of a user interface cursor over said defined area.

10. The method of claim 9 wherein said cursor automatically stays within the boundaries of the defined area.

11. The method of claim 9 wherein a user action of said user interface cursor on said cell facilitates the submission of an order to an exchange.

12. The method of claim 11 wherein said order is a trade of a commodity over an exchange.

13. An improved method for monitoring commodities over an exchange having contracts with multiple markets, the method utilizing a software application, comprising:
selecting a particular market based on a pre-determined exchange contract having a price level range;
displaying a trading screen including the current market for said market, wherein said current market includes the price level corresponding to the last trade of the commodity;
calculating the center of said current market, wherein said center of said current market is determined by the price level corresponding to the last trade of the commodity; and
automatically scrolling said trading screen such that said current market is substantially centered on the trading screen.

14. The method of claim 13 wherein said automatically scrolling scrolls at a pre-determined shift rate.

15. The method of claim 14 wherein said shift rate is between 2 and 10 pixels per 100 to 1000 milliseconds.

16. The method of claim 15 wherein said trading screen displays a grid having more than one row, each consecutive row corresponding to a consecutive valid price level, wherein said valid price level includes all price levels without regard to whether a market volume exists at those prices, and at least two columns, wherein said columns include a bid column and an offer column.

17. The method of claim 16 wherein said grid includes multiple cells, wherein each cell corresponds to a particular bid or offer at a price level.

18. The method of claim 17 wherein each cell within said grid includes a number that corresponds to the number of bids or offers that exist for a particular price level.

19. The method of claim 17 wherein said cell includes a colored bar, wherein said bar is a graphical representation of the number of bids or offers that exist for a particular price level.

20. The method of claim 19 where the physical size of the graphical representation of said colored bar is calculated using the depth quantity of that price level as the numerator and a grid basis for the denominator.

21. The method of claim 17 wherein each cell within the grid is an individually defined area responsive to pointer action of a user interface cursor over said defined area.

22. The method of claim 21 wherein said cursor automatically stays within the boundaries of the defined area.

23. The method of claim 21 wherein a user action of said user interface cursor on said cell facilitates the submission of an order to an exchange.

24. The method of claim 23 wherein said order is a trade of a commodity over an exchange.

25. An improved method for monitoring commodities over an exchange having contracts with multiple markets, the method utilizing a software application, comprising:
selecting a particular market based on a pre-determined exchange contract having a price level range;
displaying a trading screen including the pre-open market for said market, wherein said pre-open market includes an indicative opening price level prior to the opening of said market;
calculating the center of said pre-open market, wherein said center of said pre-open market is determined by the price level corresponding to the indicative opening price level; and
automatically scrolling said trading screen such that said pre-open market is substantially centered on the trading screen.

26. The method of claim 25 wherein said automatically scrolling scrolls at a pre-determined shift rate.

27. The method of claim 26 wherein said shift rate is between 2 to 10 pixels per 100 to 1000 milliseconds.

28. The method of claim 27 wherein said trading screen displays a grid having more than one row, each consecutive row corresponding to a consecutive valid price level, wherein said valid price level includes all price levels without regard to whether a market volume exists at those prices, and at least two columns, wherein said columns include a bid column and an offer column.

29. The method of claim 28 wherein said grid includes multiple cells, wherein each cell corresponds to a particular bid or offer at a price level.

30. The method of claim 29 wherein each cell within said grid includes a number that corresponds to the number of bids or offers that exist for a particular price level.

31. The method of claim 29 wherein said cell includes a colored bar, wherein said bar is a graphical representation of the number of bids or offers that exist for a particular price level.

32. The method of claim 31 where the physical size of the graphical representation of said colored bar is calculated using the depth quantity of that price level as the numerator and a grid basis for the denominator.

33. The method of claim 29 wherein each cell within the grid is an individually defined area responsive to pointer action of a user interface cursor over said defined area.

34. The method of claim 33 wherein said cursor automatically stays within the boundaries of the defined area.

35. The method of claim 33 wherein a user action of said user interface cursor on said cell facilitates the submission of an order to an exchange.

36. The method of claim 35 wherein said order is a trade of a commodity over an exchange.
